(19) United States
(12) Patent Application Publication
(10) Pub. No.: US 2011/0030828 A1
(43) Pub. Date: Feb. 10, 2011

(54) One Piece Flexible Expansion Loop For Rigid Piping Systems

(75) Inventors: Christopher P. Boyher, Medina, OH (US); Carl M. Mahabir, Streetsboro, OH (US); Andrew J. Midlik, Parma, OH (US)

Correspondence Address: THE LUBRIZOL CORPORATION, 29400 LAKELAND BLVD, MAIL DROP 022B, WICKLIFFE, OH, 44092-2298, US

(73) Assignee: LUBRIZOL ADVANCED MATERIALS, INC., Cleveland, OH (US)

(21) Appl. No.: 12/853,504

(22) Filed: Aug. 10, 2010

Related U.S. Application Data
(60) Provisional application No. 61/232,592, filed on Aug. 10, 2009.

(51) Int. Cl. F16L 51/04; F16L 33/00

(52) U.S. Cl. 138/26; 285/238

(57) ABSTRACT

A piping system for hot water-based fluid substantially above ambient temperature (10) includes at least one horizontal pipe run (20, 22). Each horizontal pipe run includes at least one flexible expansion loop (40, 42). Each flexible expansion loop is comprised of a unitary flexible body (70) which includes opposed generally linear end portions (72, 74). Curved portions of the flexible expansion loop (76, 78, 80, 82) are curved and extend transversely away from the common axis (48) of the horizontal pipe run. The flexible expansion loop is operative to accommodate changes due to the thermal expansion, water hammer and vibration while being more compact than conventional expansion loops.

### CROSS REFERENCE

This application claims benefit pursuant to 35 U.S.C. §119(e) of Provisional Application Ser. No. 61/232,592 filed on Aug. 10, 2009.

### TECHNICAL FIELD

This invention relates to flexible pipes and tubular conduits that may be classified in U.S. Class 138, Subclass 118.

### BACKGROUND ART

Piping materials of various types will expand with an increase in temperature of the fluid material being carried, and will likewise contract as the temperature of the piping system and the material cools. The amount of expansion depends on the coefficient of thermal expansion of the pipe material and the variation in temperature of the fluid material being conveyed. As a result provisions must be made to accommodate the resulting movement of the pipe due to thermal expansion and contraction.

A common situation in which the effects of thermal expansion must be accommodated is in hot water delivery systems. This includes, for example, systems that deliver heated potable water from a water heater to plumbing fixtures in houses, hotels, office buildings, factories or other structures. Another common application where the effects of thermal expansion must be addressed is in hot water heating systems. In such systems, water or water-based mixtures are transported from a hot water heating source to heat exchangers or other devices which release heat for building heating or other purposes. The water-based fluid is then returned from the radiators for recycling and reuse. Hot water and/or water-based fluids are also used in other industrial and commercial systems.

In applications of this type, the liquid is often at 80° F. to 120° F. above the ambient temperature. As a result, long runs of pipe experience substantial expansion and contraction as the fluid changes from ambient temperature, which would be common when there is no flow through the pipe such as when the system is off or no hot water is being used, to the substantially elevated temperature above ambient as heated liquid is passing through the pipe.

In order to accommodate thermal expansion in long horizontal runs of rigid pipe, expansion loops have been used. An expansion loop is most commonly an assembly of lengths of pipe and fittings that extend in a generally U-shape and that is positioned generally near the midpoint of a long, horizontal run of pipe. The purpose of the expansion loop is to provide a section in the pipe that can more readily deform to accommodate the changes in length that occur with thermal expansion and contraction. The size of the expansion loop is dependent on a number of factors including the material properties of the pipe, the length of the overall pipe run and the change in temperature that needs to be accommodated.

Conventional expansion loops have some drawbacks. These include the space required to include the expansion loop in the pipe run. Specifically, the expansion loop must extend transversely relative to the longitudinal axis of the pipe a sufficient distance to allow deformation from expansion and contraction to occur without placing undue stress on the components of the expansion loop. In some situations, such as in buildings where space is at a premium and pipe runs must extend within a limited building area, there may not be sufficient room for a properly sized expansion loop. This may result in failure and leakage.

A further drawback is the cost associated with installing an expansion loop. This includes, for example, four 90° fittings and the pipe sections between the fittings required to form the U-shaped expansion loop. Further, each of the joints which must be included (2 per fitting) are each a potential source of failure and leakage. This is particularly true in an expansion loop which functions to tolerate substantial deformation that results from thermal expansion and contraction. The risk of failure is further increased by the lateral forces that are applied to the main pipe sections by virtue of the 90° fittings that are commonly used for the expansion loop. Such bends can apply lateral forces on the pipe sections which apply stresses and which may eventually cause fatigue and failure. In addition, the effects of water hammer and vibration on such 90° joints can further deteriorate the connection and cause premature failure.

As a result, piping systems that carry hot liquids substantially above ambient temperature may benefit from improvements.

### OBJECTS OF EXEMPLARY EMBODIMENTS

It is an object of an exemplary embodiment to provide an expansion loop for use in piping systems.

It is a further object of an exemplary embodiment to provide a flexible expansion loop for use in connection with rigid piping systems.

It is a further object of an exemplary embodiment to provide an expansion loop for accommodating the effects of thermal expansion in rigid piping systems that consumes less space.

It is a further object of an exemplary embodiment to provide a flexible expansion loop for use in connection with rigid piping systems that accommodates the effects of thermal expansion and which is more resistant to failure.

It is a further object of an exemplary embodiment to provide a method of making a flexible thermal expansion loop.

It is a further object of an exemplary embodiment to provide a method of making a flexible thermal expansion loop for use in connection with hot water delivery systems.

It is a further object of an exemplary embodiment to provide a method for making a flexible thermal expansion loop that is suitable for use in a variety of physical and thermal environments.

It is a further object of an exemplary embodiment to provide a method of making a system for conveying hot liquids that includes a flexible thermal expansion loop.

It is a further object of an exemplary embodiment to provide a method of making a system for delivering liquids at elevated temperatures that includes a thermal expansion loop that is more compact and resistant to failure.

Further objects of exemplary embodiments will be made apparent in the following Detailed Description of Exemplary Embodiments and the appended claims.

The foregoing objects are accomplished in exemplary embodiments by an expansion loop that is configured to fluidly connect a first rigid fluid pipe section and a second rigid fluid pipe section. The first and second rigid fluid pipe sections are generally linearly aligned with a common axis and extend horizontally. The first and second rigid fluid pipe sections are adapted to carry liquid such as hot water at a temperature substantially higher than ambient temperature. This may be, for example, 80° F. to 120° F. above ambient temperature. At least one of the first and second rigid fluid pipe sections is operatively connected to a source of heated water such as a water heater. In some exemplary embodiments, the first and second rigid fluid pipe sections include pipes comprised of chlorinated polyvinylchloride (CPVC). Of course, it should be understood that this material is exemplary and in other embodiments other types of rigid pipe sections such as copper, iron or other types of metal or rigid plastic pipe may be used.

In the exemplary embodiment, the first and second rigid pipe sections are fluidly connected through an expansion loop which is comprised of a unitary body of flexible material. The body includes generally opposed first and second end openings. The end openings are configured for operative fluid connection with the first and second rigid pipe sections respectively. In the exemplary embodiment, the first and second end openings may be fluidly connected to the rigid pipe sections through suitable couplings or other fluid connector devices. The body of the expansion loop bounds a continuous closed conduit which extends between the first and second openings. The body is comprised of flexible plastic material that includes at least one curved portion that extends transversely away from the common axis. The at least one curved portion extends sufficiently transversely so that the effect of thermal expansion between the rigid pipe sections is readily accommodated by deformation of the flexible expansion loop. In addition, the flexible expansion loop tolerates the effects of vibration and other conditions such as water hammer without imparting excessive stresses to intermediate fittings so as to cause fatigue or breakage.

In the exemplary embodiment, the body of the expansion loop includes a pair of opposed first and second fluid end portions and includes the first and second end openings, respectively. These end portions extend in generally aligned relation with the common axis. Each of these end portions are in adjacent connection with first and second curved portions respectively that curve in opposed directions and away from the common axis. In the exemplary embodiment, the first and second curved portions extend at an angle so that they are curved away from the axis at an angle of more than 90°.

In the exemplary embodiment, the first curved portion is in adjacent connection with a third curved portion that is curved in the opposite direction relative to the first curved portion. Likewise, a third curved portion is in adjacent connection with the second curved portion and is curved in an opposed direction thereto. Further, in the exemplary embodiment, the third curved portion and the fourth curved portion are in adjacent connection with one another. As a result, the exemplary embodiment of the expansion loop includes a “lightbulb” shape. This lightbulb shape of the exemplary embodiment is desirable as it provides the ability to accommodate significant changes in position and deformation due to thermal expansion and contraction without producing high lateral stresses on the end portions or substantial fatigue stresses on any intermediate fittings.

However, it should be understood that other shapes for the expansion loop that may be used in other embodiments. These may include, for example, spiral loops or structures that are curved in one or multiple planes relative to the common axis of the rigid fluid pipe sections.

In the exemplary embodiment, the expansion loop is comprised of cross linked polyethylene (PEX) tubing. Such tubing is well suited for use in hot water environments. Of course in other embodiments other materials may be used.

In the exemplary embodiment, the expansion loop is formed from a length of extruded or otherwise formed PEX tubing of a suitable size. The PEX tubing is originally generally straight and relatively flexible after it has been formed through a normal manufacturing process. In this exemplary embodiment, a length of such tubing is placed in a suitable forming structure such as between a pair of heated die plates. The die plates may include opposed recesses which have the desired shape of the expansion loop. In the exemplary embodiment, the die plates are heated to an elevated temperature of between 125° C. and 175° C. The generally straight PEX tubing section is placed between the dies and held for a suitable time at the elevated temperature. The dies are then cooled and the expansion loop removed. Heating of the PEX material to this temperature causes the body of the expansion loop to take on a permanent set of the desired shape. However, after taking on the permanent set, the tubing continues to have its desirable flexibility and other properties for use as a hot water conduit. Of course, it should be understood that this process is exemplary and in other embodiments other approaches may be used.

In forming a piping system, rigid fluid conduits such as CPVC pipe are placed in operative connection with a hot water heater or other source of fluid that is substantially above ambient temperature. In order to accommodate the effects of thermal expansion, CPVC pipe included in a long horizontal run is configured to have a space between sections to accept installation of the expansion loop approximately half way through the run.

In an exemplary embodiment, a first rigid pipe is terminated and a suitable coupler is installed on the end of the terminated rigid pipe section. In the exemplary embodiment, the coupler includes a CPVC pipe coupling that is attached in cemented connection with the end of the first rigid pipe section. The connector is then installed in cemented relation in the other end of the coupling. In the exemplary embodiment, the connector includes a cylindrical plug portion comprised of CPVC. The cylindrical plug portion includes a barbed metal fitting molded therein. The barbed metal fitting is sized to extend into the first end opening of the expansion loop. The barbed fitting is extended the first end opening of the expansion loop and the loop is secured in engagement with the connector by crimping a copper ring externally of the expansion loop in overlying relation of the barbed fitting.

The second fluid end portion of the expansion loop which includes the second end opening, is similarly attached to an opposed second rigid pipe section. Further, in some exemplary embodiments, the expansion loop may be formed such that one or both of the fluid end portions have excess linear length so that an unneeded portion thereof may be cut off to accommodate the particular distance between the first and second rigid pipe sections. In the exemplary embodiment, the second rigid pipe section includes a plastic coupling in cemented connection therewith and a connector with a barbed fitting that is extended into the second end opening and secured thereto with a crimped external copper band.

Of course, it should be understood that the particular coupling methodologies associated with the exemplary embodiments are only examples of the many ways in which the principles of the present invention may be applied.

### BRIEF DESCRIPTION OF DRAWINGS

FIG. 1 is a schematic view of an exemplary system for delivering fluid at elevated temperatures that includes flexible expansion loops of the exemplary embodiment.

FIG. 2 is an isometric view of an exemplary expansion loop connecting first and second rigid pipe sections.

FIG. 3 is a plan view of an exemplary expansion loop of the type shown in FIG. 2.

FIG. 4 is a cross sectional view showing a coupling and connector used with an exemplary embodiment of the expansion loop.

FIG. 5 shows a section of tubing to be used in making an exemplary expansion loop, prior to being formed to a desired shape.

FIG. 6 is an isometric view of an exemplary heated die plate that is used for forming an expansion loop of the shape of the exemplary embodiment.

### DETAILED DESCRIPTION OF EXEMPLARY EMBODIMENTS

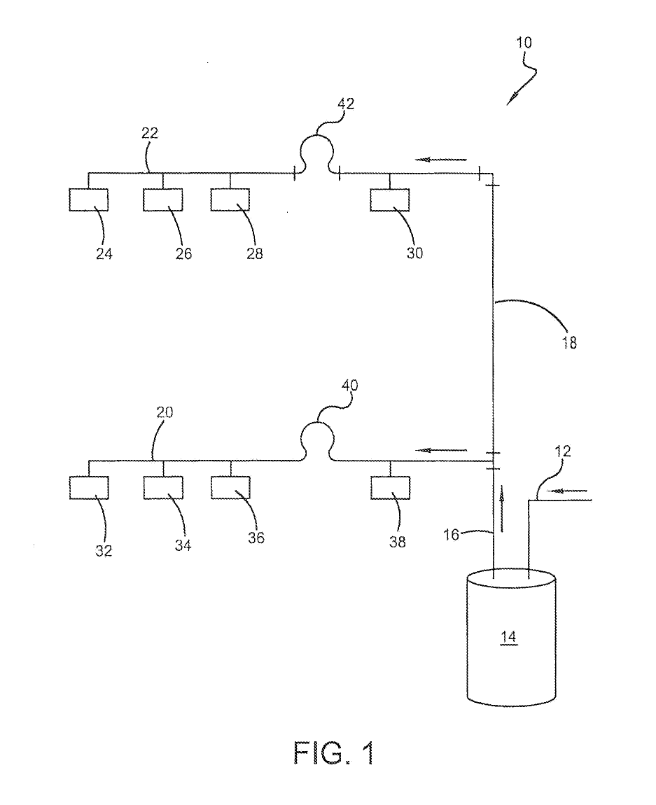

Referring now to the drawings and particularly to FIG. 1, there is shown therein a schematic simplified view of a piping system generally indicated 10. System 10 of this exemplary embodiment is a hot water delivery system such as might be used in a building for the delivery of hot water. In this exemplary embodiment, water is supplied from a source through an inlet line 12. Inlet line 12 may be from a source of city water or other suitable water source. Inlet line 12 feeds water into a water heater device 14. Water heater device 14 operates to heat the water fed into it through inlet line 12 to a temperature substantially above ambient temperature. For example, in some embodiments, the water heater device 14 may heat the water to a temperature that is 80° F. to 120° F. above the ambient temperature.

Water exits the water heater device through an outlet line 16. Outlet line 16 delivers the water at elevated temperature through one or more risers 18. Riser 18 in this exemplary embodiment delivers the heated water through two horizontal pipe runs 20 and 22 respectively. Each of the horizontal pipe runs has fluidly connected therewith, water using devices 24, 26, 28, 30, 32, 34, 36 and 38. The water using devices may in various embodiments include devices that utilize water at elevated temperatures. These may include for example plumbing fixtures, such as outlets associated with sinks, bathtubs, showers, wash tubs, washing machines, hose outlets or other types of devices through which hot water may be delivered.

Each horizontal pipe run 20 and 22 includes an expansion loop of an exemplary embodiment of the type described herein. Horizontal pipe run 20 includes an expansion loop 40 while horizontal pipe run 22 includes an expansion loop 42. In the exemplary embodiment, each horizontal run is comprised of generally rigid pipe material such as CPVC pipe complying with the requirements of ASTM D2846. In the exemplary embodiment, the expansion loops are positioned generally along the length of the horizontal pipe run and are comprised of continuous flexible conduit which is configured to move and deform with the thermal expansion and contraction of the adjacent rigid pipe sections. In the exemplary embodiment, the expansion loops are comprised of a unitary piece of PEX tubing that has been shaped through heat processing in the manner hereafter described so as to enable relative movement of the adjacent rigid pipe sections through deformation without excessive stress or fatigue.

It should be understood that although the exemplary embodiment is discussed in connection with rigid piping comprised of CPVC, and a flexible expansion loop that is comprised of PEX tubing, other embodiments may use other materials. For example, other embodiments may use other forms of generally rigid pipe such as copper, iron or other metallic or rigid plastic materials. Likewise, the expansion loop may be generally comprised of a flexible body that is compatible with the fluid, pressure and temperature of the particular system.

It should further be understood that while the exemplary embodiment of the system 10 is a hot water delivery system, other types of systems may be used in connection with other embodiments. These may include, for example, thermal heating systems that employ a water-based fluid for purposes of residential, commercial or industrial heating. Such systems may include, for example, closed loop systems in which a working fluid is heated and conveyed to heat exchangers for purposes of delivering heat, and then is returned through a collection unit for reheating. Alternatively, the principles described herein may be used in other types of systems in which liquids of various types that have been heated above ambient temperatures are delivered through generally rigid pipes.

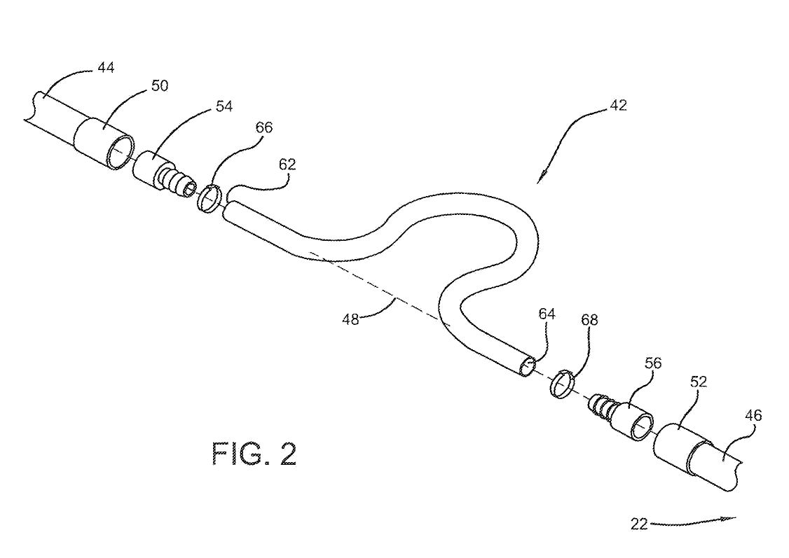

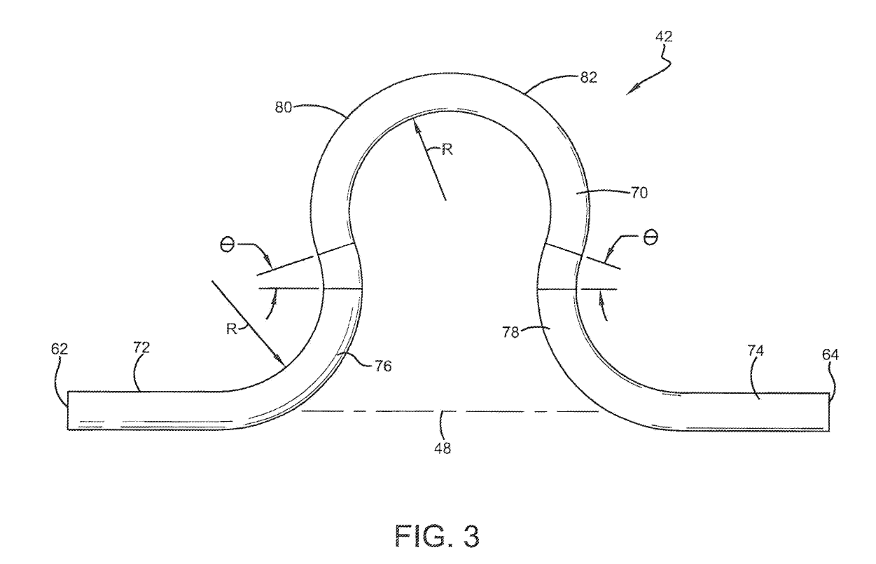

FIGS. 2 and 3 show greater detail regarding the expansion loop of the exemplary embodiment. Because expansion loops 40 and 42 are generally identical, only expansion loop 42 will be described.

In this exemplary embodiment, expansion loop 42 extends in horizontal run 22. Horizontal run 22 includes a first rigid pipe section 44 and a second rigid pipe section 46. First and second rigid pipe sections 44 and 46 extend along generally a common axis schematically represented 48. As can be appreciated, in the exemplary embodiment, common axis 48 extends generally horizontally. However, in other embodiments, other approaches may be used. Further, it should be understood that for purposes of this disclosure, pipe sections that extend in generally parallel directions for a substantial distance will be considered to extend along a common axis even though they may be somewhat transversely offset from one another. The expansion loop of this invention can be used with horizontal runs of piping as well as vertical runs of piping or piping runs at an angle to horizontal. Also, the expansion loop can be used to redirect the piping run at a slight angle.

In the exemplary embodiment, first rigid pipe section 44 includes a coupling 50 at the end thereof. In the exemplary embodiment, coupling 50 comprises a CPVC coupling that complies with the requirements of ASTM D2846. Coupling 50 is attached in fluid tight relation with the rigid pipe section through a cemented connection. Similarly, second rigid pipe 46 has attached thereto a similar coupling 52.

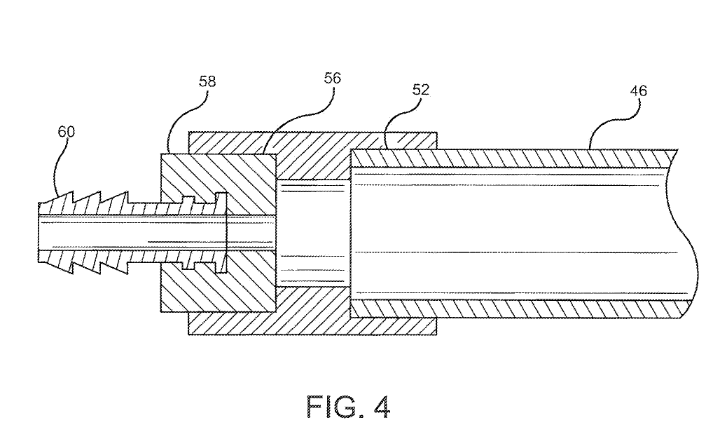

Each of couplings 50 and 52 have in connection therewith a respective exemplary connector 54, 56. Each of these connectors is of a similar construction which is best shown in the cross sectional view of connector 56 shown in FIG. 4. Each connector includes a plug portion 58 which is sized for acceptance in the respective coupling through a fluid tight cemented connection. In the exemplary embodiment, the plug portion is comprised of CPVC. The plug portion of the connector has in molded connection therewith a barbed metallic fitting 60 such as is shown in FIG. 4. In the exemplary embodiment, the barbed metallic fittings may be of the type that complies with the requirements of ASTM F1807. Of course this structure is exemplary and in other embodiments other approaches may be used.

In the exemplary embodiment, the barbed fitting of connector 54 is sized for acceptance in a first end opening 62 in an expansion loop 42. Likewise, the barbed metallic fitting of connector 56 is sized for acceptance in a second end opening 64 of expansion loop 42. Further, in the exemplary embodiment, once the barbed metallic fittings have been extended into the respective end openings, the expansion loop and the connectors are secured together through the overlying placement and deformation of copper crimp rings 66 and 68. However, it should be understood that this method of attaching and securing the expansion loop to the respective first and second rigid pipe sections is exemplary and in other embodiments other fluid connectors and approaches may be used.

The exemplary expansion loop 42 is shown in greater detail in FIG. 3. In this exemplary embodiment, the expansion loop 42 is comprised of a unitary body 70 of generally circular cross section. The unitary body is comprised of continuous flexible plastic material that bounds a continuous closed conduit that extends between the first end opening 62 and the second end opening 64. As later discussed in detail, the exemplary embodiment is formed of post-production shaped PEX tubing that has been heat processed so as to have a permanent set in the configuration shown. This processing provides for the body to remain flexible and resilient while maintaining the desirable properties of flexibility, strength and resistance to fatigue of PEX tubing that complies with ASTM F876. Of course, it should be understood that this approach is exemplary, and in other embodiments other approaches may be used.

As can be appreciated, the exemplary expansion loop is configured so that it includes one or more curved portions that extend transversely away from the common axis 48 of the rigid pipe sections. In this way, the curved portions are configured to enable relative movement of the rigid pipe sections due to conditions such as thermal expansion, water hammer, vibration and the like without posing substantial resistance to the relative movement of the rigid pipe sections and without causing undue stress or fatigue in the pipe sections or in the expansion loop. It should be understood that while the exemplary embodiment of the expansion loop has the particular configuration described in detail herein, other embodiments may include other shapes that are suitable for fluidly connecting rigid pipe sections while accommodating the relative movement of such rigid pipe sections.

In the exemplary configuration of expansion loop 42, the loop includes a first fluid end portion 72. In the installed position, fluid end portion 72 extends in generally linearly aligned relation with the first rigid pipe section. Similarly, the expansion loop includes a second fluid end portion 74 which includes second end opening 64 and extends generally in linearly aligned relation with the second rigid pipe section. In the exemplary embodiment of a one inch pipe size expansion loop, the fluid end portions generally extend about four inches in length. However, other configurations may be used. An advantage of the fluid end portions of the expansion loop being generally linearly aligned with the adjacent rigid pipe sections is that this approach helps to assure that the forces applied at the respective connectors act generally linearly along the common axis and the force applied by or on the loop has relatively small if any transverse components. By minimizing the transverse force acting on the fluid connectors, the risk of failure of the fluid tight connections between the connectors of the expansion loop is reduced. However, it should be understood that the length of the end portions may vary depending on the particular configuration of the particular type of expansion loop and the piping involved.

Returning to the description of the exemplary embodiment of the expansion loop in FIG. 3, the first fluid end portion 72 is connected in adjacent connection with a first curved portion generally indicated 76. When used herein, the terminology that a particular feature of the expansion loop is in adjacent connection with another feature, means that there is no intermediate section of the expansion loop that is substantially curved and that is positioned between the features. This means, for example, that a generally straight section of the expansion loop may extend between the features that are described and be in adjacent connection with one another without contravening the described relationship.

In the exemplary expansion loop 42, first curved portion 76 is curved transversely away from the common axis 48. In addition, the first curved portion extends at an angle away from the common axis that is greater than 90°. In the exemplary embodiment, the angle of curvature of the first curved portion 76 is approximately 110°, or in other words 20° beyond a 90° bend. Of course, this approach is exemplary and in other embodiments other approaches may be used.

Similarly, second fluid end portion 74 is in adjacent connection with a second curved portion 78. Second curved portion 78 is curved in an opposite angular direction to first curved portion 76. Further, in this exemplary embodiment, second curved portion 78 is also curved more than 90° and is a mirror image of the first curved portion. In addition, the first and second curved portions 76 and 78 of this exemplary embodiment extend away from the common axis transversely and in a single plane. This is not necessarily the case with regard to other embodiments which may include portions which extend away from the common axis in a transverse direction in several different planes.

In an exemplary embodiment, the first curved portion 76 is in adjacent connection with a third curved portion 80. Third curved portion 80 is curved in an opposed direction to first curved portion 76. In the exemplary embodiment, third curved portion 80 extends to the point of maximum transverse displacement from the common axis.

In this exemplary embodiment, a fourth curved portion 82 extends in adjacent connection with second curved portion 78. Fourth curved portion 82 is curved in an opposed direction of the second curved portion and is a mirror image of third curved portion 80. Fourth curved portion 82 extends in adjacent connection with third curved portion 80 and forms a continuous arcuate configuration therewith.

In an exemplary embodiment for a one inch pipe diameter expansion loop, the radius R between the third and fourth curved portions is generally about three inches. Likewise, a similar radius of curvature is used for the first and second curved portions. Further, in this exemplary embodiment, the minimum distance between the first and second curved portions is approximately five inches. The maximum distance which the third and fourth portions extend away from the common axis 48 is approximately ten inches. Further, in this exemplary embodiment, the fluid conduit length of the expansion loop is approximately 35 inches while the lineal distance of the expansion loop between the first and second end openings is approximately 21 inches. Of course, it should be understood that this configuration is exemplary and in other embodiments other configurations may be used.

The exemplary embodiment of the expansion loop shown is designed to accommodate thermal expansion in a system which utilizes CPVC pipe of a one inch pipe size that is suitable for use in connection with the horizontal pipe run that extends approximately 100 feet. In accordance with conventional engineering practice, for a horizontal run of this length an expansion loop which experiences a temperature change of approximately 80° F. would require a U-shaped loop that extends approximately 19½″ in a direction transverse of the common axis of the pipe sections. Thus, as can be appreciated, the expansion loop of the exemplary embodiment extends only about one-half of the transverse distance of a conventional expansion loop. This enables the expansion loop to be positioned within a smaller space. This includes, for example, between adjacent supports or other structures within the building. As a result, the exemplary expansion loop can be utilized more readily in long pipe runs.

A further advantage of the exemplary embodiment is that expansion loops of conventional construction require four 90° elbows and three intermediate pipe sections for their construction. This presents the drawback of requiring eight cemented or other joints for the connection of the expansion loop with the horizontal pipe sections. Further, the rigid structure of a conventional expansion loop presents opportunities for stresses with movement caused by thermal expansion, water hammer, vibration and other forces. This increases the probability of failures and leaks. These risks are reduced through use of the exemplary embodiment.

Certain advantages of the exemplary embodiment can be appreciated by comparing the expansion loop size required for CPVC pipe sold under the trademarks FlowGuard Gold® and Corzan® Lubrizol Corporation. Using these particular types of pipes as examples, Equation 1 below describes how the length of a conventional expansion loop is calculated.

$$Expansion Loop Formula$$

$$ℒ = \sqrt{\frac{3 ED ( Δ L )}{ZS}} \qquad ( 1 )$$

Where:
L=Loop length (in.)
E=Modulus of elasticity at maximum temperature (psi) (Table 1)
S=Working Stress at maximum temperature (psi) (Table 1)
D=Outside diameter of pipe (in.) (Tables 2 and 3)
ΔL=Change in length due to change in temperature (in.) (see Equation 2)
   The change in length of the pipe due to thermal expansion is calculated using the following formula.

Thermal Expansion Formula

ΔL=LₚCΔT (2)

Where:
ΔL=Change in length due to change in temperature (in.)
Lₚ=length of pipe (in.)
C=Coefficient of thermal expansion (in./in. ° F.) for CPVC
ΔT=Change in temperature (° F.)

The values for the modulus of elasticity and the dimensions for the FlowGuard Gold and Corzan pipes used in the Equations are found in Tables 1-3 below.

TABLE 1
Modulus of Elasticity and Working Stress for CPVC

| Temperature (° F.) | Modulus, E (psi) | Stress, S (psi) |
|---|---|---|
| 73 | 423,000 | 2000 |
| 90 | 403,000 | 1800 |
| 110 | 371,000 | 1500 |
| 120 | 355,000 | 1300 |
| 140 | 323,000 | 1000 |
| 160 | 291,000 | 750 |
| 180 | 269,000 | 500 |

TABLE 2
FlowGuard ® Gold Pipe Dimensions
SDR 11 (ASTM D2846)

| Nominal Pipe Size (in.) | Average OD Inches | Average ID Inches |
|---|---|---|
| ½ | 0.625 | 0.489 |
| ¾ | 0.875 | 0.715 |
| 1 | 1.125 | 0.921 |
| 1¼ | 1.375 | 1.125 |
| 1½ | 1.625 | 1.329 |
| 2 | 2.125 | 1.739 |

TABLE 3
Corzan Pipe Dimensions
Schedule 80 (ASTM F441)

| Nominal Pipe Size (in.) | Average OD Inches | Average ID Inches |
|---|---|---|
| ½ | 0.840 | 0.528 |
| ¾ | 1.050 | 0.724 |
| 1 | 1.315 | 0.935 |
| 1¼ | 1.660 | 1.256 |
| 1½ | 1.900 | 1.476 |
| 2 | 2.375 | 1.913 |
| 2½ | 2.875 | 2.289 |
| 3 | 3.500 | 2.864 |
| 4 | 4.500 | 3.786 |
| 6 | 6.625 | 5.709 |
| 8 | 8.625 | 7.565 |
| 10 | 10.750 | 9.492 |
| 12 | 12.750 | 11.294 |
| 14 | 14.000 | 12.410 |
| 16 | 16.000 | 14.214 |

Tables 4 and 5 show respectively the lineal length L of the expansion loop required for a given horizontal run of pipe to accommodate the temperature change of approximately 80° F.

TABLE 4
FlowGuard Gold Pipe SDR 11 (ASTM D2846)
Calculated Loop (Offset) Lengths with ΔT of approx. 80° F.

| Nominal | Length of Run in Feet | | | | |
|---|---|---|---|---|---|
| Pipe | 40 | 60 | 80 | 100 | 120 |
| Size (in.) | Loop Length (L) in Inches | | | | |
| ½ | 23 | 28 | 33 | 36 | 40 |
| ¾ | 27 | 33 | 39 | 43 | 47 |
| 1 | 31 | 38 | 44 | 49 | 54 |
| 1¼ | 34 | 42 | 48 | 54 | 59 |
| 1½ | 37 | 45 | 53 | 59 | 64 |
| 2 | 42 | 52 | 60 | 67 | 74 |

TABLE 5
Corzan Pipe Schedule 80 (ASTM F441)
Calculated Loop (Offset) Lengths with ΔT of approx. 80° F.

| Nominal | Length of Run in Feet | | | | |
|---|---|---|---|---|---|
| Pipe | 40 | 60 | 80 | 100 | 120 |
| Size (in.) | Loop Length (L) in Inches | | | | |
| ½ | 27 | 33 | 38 | 42 | 46 |
| ¾ | 30 | 37 | 42 | 47 | 52 |
| 1 | 33 | 41 | 47 | 53 | 58 |
| 1¼ | 38 | 46 | 53 | 59 | 65 |
| 1½ | 40 | 49 | 57 | 64 | 70 |
| 2 | 45 | 55 | 64 | 71 | 78 |
| 2½ | 49 | 61 | 70 | 78 | 86 |
| 3 | 55 | 67 | 77 | 86 | 94 |
| 4 | 62 | 76 | 87 | 98 | 107 |
| 6 | 75 | 92 | 106 | 119 | 130 |
| 8 | 86 | 105 | 121 | 135 | 148 |
| 10 | 96 | 117 | 135 | 151 | 165 |
| 12 | 104 | 127 | 147 | 165 | 180 |

In accordance with recommended engineering practice for a conventional U-shaped expansion loop in each of these types of piping systems, the transverse distance that the loop will extend from the common axis of the horizontal pipe run is 2L/5. As can be appreciated from these numbers and the foregoing example, using the flexible expansion loop of the exemplary embodiment, for a 100 foot horizontal run, a 1 inch pipe and 80° F. temperature rise the transverse distance which the expansion loop extends can generally be reduced by about 50 percent from that conventionally required. Further, in other embodiments and through the provision of different configurations of flexible expansion loops, further reductions may be achieved. Of course, this depends on the particular type of pipe involved, the size and the temperature differentials which are encountered.

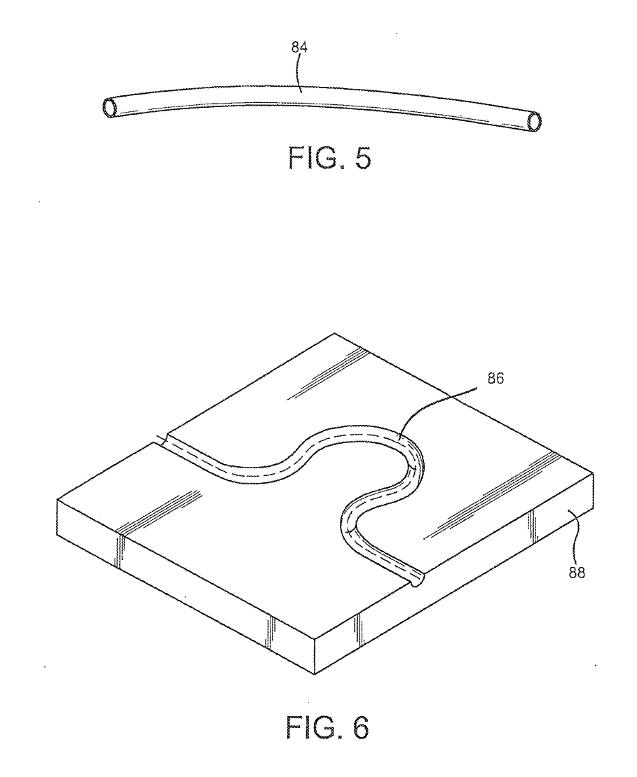

The exemplary method of making the expansion loop of the exemplary embodiment is represented schematically in FIGS. 5 and 6. In the exemplary method, a length of extruded PEX tubing generally indicated 84, is generally made to have little or no permanent set at the time of manufacture. In this exemplary embodiment, the tubing length of PEX tubing may be approximate 35 inches of one inch tubing to form expansion loop previously discussed. In the exemplary embodiment, the PEX tubing may be comprised of a multilayer material including an external layer which includes a desired pigment. This may include, for example, in hot water applications, a red pigment. Such a red pigment may be used to indicate to users that the material is suited for hot water applications. Of course, in other embodiments, other pigmented materials may be used. Further, in some exemplary embodiments, the tubing may be comprised of an inner layer of PEX material of a different suitable color. Of course these approaches are exemplary.

For producing the flexible expansion loop of the exemplary embodiment, the tubing will be of a size allowed per ASTM F876. The material will preferably enable achieving an ASTM F2023 rating designation of 5006 which is suitable for 100 percent hot water recirculation systems. Of course, it should be understood that these properties are associated with an exemplary embodiment and in other embodiments other approaches may be used.

The flexible expansion loop of the described configuration is formed post manufacture to have the light bulb shape previously described. This can be accomplished through a number of different processes which involve elevating the temperature of the tubing to a point where the material can be formed and take on a permanent set when cooled, but which will not destroy the desirable properties of the original material. In the exemplary embodiment, the expansion loop is formed by extending the length of tubing in a suitably shaped recess 86 in a heated die plate 88 of the type schematically shown in FIG. 6. A conforming die plate which is configured to engage die plate 88 may be brought adjacent thereto once the tubing has been positioned therein. In the exemplary process, the tubing is heated above approximately 125° C. and below approximately 175° C. In this method, once the tubing has been fully heated to within this temperature range, the plates may be separated, cooled and the tubing is removed. Once cooled, the tubing takes on a permanent set in the shape of the recess 86. Of course, it should be understood that this process is exemplary and in other embodiments other processes may be used.

Piping systems including expansion loops of the type described may be produced by methods that include extending a first rigid pipe section generally horizontally within a building or other facility through which liquid substantially above ambient temperature is to be conducted. The first pipe section is adapted to be in operative connection with a source of heated liquid such as a water heating device or other device that delivers a liquid such as water or a water-based fluid that is substantially above ambient temperature.

A second generally rigid pipe section is positioned in generally aligned relation along a common axis of the first pipe section. A flexible expansion loop is fluidly connected between the first and second rigid pipe sections. The flexible fluid expansion loop is preferably comprised of a unitary body with at least one curved portion that extends transversely away from a common axis and which accommodates relative movements of the first and second rigid pipe sections due to thermal expansion, vibration, water hammer or other conditions. Further, in the exemplary embodiment, the method includes attaching a respective coupling to each of the respective first and second rigid pipe sections. Such a coupling will be of the type suitable for operatively connecting the flexible expansion loop. In situations where the rigid pipe sections are comprised of CPVC pipe, the couplings may be plastic couplings which are attached to the respective rigid pipe sections in cemented relation.

Further, in exemplary embodiments, the method may include attaching a respective connector to each respective coupling. The connector is of a type that is suitable for fluidly connecting the coupling and the expansion loop. In the exemplary embodiment which comprises CPVC pipe, the connector includes a CPVC plug portion that is attached in cemented connection with the respective coupling. The plug portion has attached thereto a barbed metal fitting connection which is extended into a respective end opening of the expansion loop, and secured thereto with an overlying crimped copper ring. Of course, it should be understood that these approaches are particularly suited for use in connection with an exemplary embodiment, and in other embodiments such as those using other types of rigid pipe and particularly metallic pipes, other couplings, connectors or other devices suitable for fluidly connecting the flexible expansion loop may be used.

Thus, the exemplary embodiments achieve at least some of the above stated objectives, eliminate difficulties encountered in the use of prior devices, systems and methods, solve problems and attain the desirable results described herein.

In the foregoing description, certain terms have been used for brevity, clarity and understanding, however no unnecessary limitations are to be implied therefrom because such terms are used for descriptive purposes and are intended to be broadly construed. Moreover, the descriptions and illustrations herein are by way of examples and the invention is not limited to the exact details shown and described.

In the following claims, any feature described as a means for performing a function shall be construed as encompassing any means known to those skilled in the art as being capable of performing the recited function, and shall not be limited to the structures shown herein or mere equivalents thereof. The provision of an abstract herewith likewise shall not be construed as limiting the claims to the features or functions described in the abstract.

Having described the features, discoveries and principles of the invention, the manner in which it is constructed and operated, and the advantages and useful results attained; the new and useful structures, devices, elements, arrangements, parts, combinations, systems, equipment, operations, methods, processes and relationships are set forth in the appended claims.

I claim:

1. Apparatus comprising:
an expansion loop configured to fluidly connect a first rigid fluid pipe section and a second fluid pipe section, wherein the first and second pipe sections are generally linearly aligned along a common axis, and wherein at least one of the first and second pipe sections is in operative connection with a source of liquid having a temperature substantially higher than ambient temperature;
wherein the expansion loop comprises a unitary body;
wherein the body includes generally opposed first and second end openings configured for operative fluid connection with the first and second pipe sections, respectively;
wherein the body bounds a continuous closed conduit between the first and second end openings, and wherein the body is comprised of flexible plastic material that includes at least one curved portion that in the undeformed condition extends transversely away from the common axis.

2. The apparatus according to claim 1 wherein the body is generally a continuous circular cross section and wherein the body further includes:
a first fluid end portion, wherein the first fluid end portion includes the first end opening;
a second fluid end portion, wherein the second fluid end portion includes the second end opening;
wherein the first fluid end portion is configured to extend in linearly aligned relation with the first pipe section;
wherein the second fluid end portion is configured to extend in linearly aligned relation with the second pipe section.

3. The apparatus according to claim 2 wherein the body is heat processed to include a permanent set that includes the at least one curved portion.

4. The apparatus according to claim 3 wherein the body includes a first curved portion and a second curved portion, wherein each of the respective first and second curved portions extend transversely away from the common axis.

5. The apparatus according to claim 4 wherein the first and second curved portions extend in a common plane that includes the common axis.

6. The apparatus according to claim 4 wherein the first and second curved portions each extend in different respective planes.

7. The apparatus according to claim 5 wherein the first and second curved portions each extend in opposed curved directions.

8. The apparatus according to claim 7 wherein the first curved portion is in adjacent connection with the first fluid end portion, and the second curved portion is in adjacent connection with the second fluid end portion.

9. The apparatus according to claim 8 wherein the body further includes:
a third curved portion, wherein the third curved portion is in adjacent connection with the first curved portion;
and wherein the third curved portion is curved in an opposed direction relative to the first curved portion.

10. The apparatus according to claim 9 wherein the body further includes:
a fourth curved portion, wherein the fourth curved portion is in adjacent connection with the second curved portion;
and wherein the fourth curved portion is curved in an opposed direction relative to the second curved portion.

11. The apparatus according to claim 10 wherein at least one of the first curved portion and the second curved portion are curved at an angle more than 90° relative to the respective adjacent first and second fluid end portion.

12. The apparatus according to claim 11 wherein each of the first curved portion and second curved portion are curved more than 90° relative to the respective adjacent first and second fluid end portions.

13. The apparatus according to claim 12 wherein the third curved portion is in adjacent fluid connection with the fourth curved portion.

14. The apparatus according to claim 13 wherein the body is comprised of cross linked polyethylene (PEX).

15. The apparatus according to claim 14 wherein the body is comprised of generally linear PEX conduit heat processed after manufacture to include the first, second, third and fourth curved portions.

16. The apparatus according to claim 15 wherein the PEX includes red pigment, whereby the body has a red external appearance.

17. The apparatus according to claim 15 wherein at least one of the first and second rigid pipe sections is comprised of copper.

18. The apparatus according to claim 15 wherein at least one of the first and second rigid pipe sections is comprised of rigid plastic pipe.

19. The apparatus according to claim 18 wherein at least one of the first and second end openings is configured to accept a barbed metal fitting therein.

20. The apparatus according to claim 19 and further comprising:
a connector, wherein the connector includes a cylindrical plug portion and a barbed metal fitting;
wherein the plug portion is comprised of plastic material, and wherein the metal fitting is in molded connection with the plug portion, and wherein the barbed metal fitting extends in the first end opening of the expansion loop.

21. The apparatus according to claim 20 and further comprising:
a plastic coupling, wherein the plastic coupling is in operative connection with one of the first and second rigid pipe sections, and wherein the plastic coupling includes a cylindrical recess, and wherein the plug portion is in cemented fluid tight connection in the recess.

22. The apparatus according to claim 21 wherein the coupling first rigid pipe section and plug portion are each comprised of chlorinated polyvinylchloride (CPVC).

23. The apparatus according to claim 22 and further comprising a hot water heater, wherein the expansion loop is in operative fluid connection with the hot water heater.

24. The apparatus according to claim 1 wherein the body is comprised of PEX.

25. The apparatus according to claim 1 wherein at least one of the first and second rigid pipe sections is comprised of CPVC.

26. The apparatus according to claim 1 wherein the body is comprised of at least two oppositely curved portions.

27. The apparatus according to claim 26 wherein the at least two oppositely curved portions are curved more than 90° relative to the common axis.
